(19) United States
(12) Patent Application Publication
(10) Pub. No.: US 2018/0265154 A1
(43) Pub. Date: Sep. 20, 2018

(54) ENCLOSED ELECTRIC CARGO TRICYCLE

(71) Applicant: William Mulyadi, LA JOLLA, CA (US)

(72) Inventor: William Mulyadi, LA JOLLA, CA (US)

(21) Appl. No.: 15/461,341

(22) Filed: Mar. 16, 2017

(51) Int. Cl. B62K 5/05; B62K 5/06; B62K 5/027; B62K 7/04; B62M 6/70; B62M 1/36; B62K 21/12; B62M 9/02; B62J 17/00; B62J 7/02; B60J 5/04

(52) U.S. Cl. CPC B62K 5/05; B62K 5/06; B62K 5/027; B62K 7/04; B62M 6/70; B60J 5/0486; B62K 21/12; B62M 9/02; B62J 17/00; B62J 7/02; B62M 1/36

(57) ABSTRACT

An enclosed electric tricycle is disclosed for use in an urban commuting environment. Aspects of the enclosed electric tricycle keep it balanced, protect the rider from the environment, and allow the rider higher visibility to see and be seen by adjacent car drivers. An electric assist feature provides the rider supplemental power during a commute, which may be especially helpful in hilly areas or longer distance commutes.

### BACKGROUND

The embodiments herein relate generally to vehicles, and more particularly, to an enclosed electric cargo tricycle.

Current options for travelling within an urban area limit the mobility and efficiency of movement by a person. The commute in some urban areas may be too distant and/or too hilly for one to travel on a daily basis. Yet some urban areas are too crowded for daily use and storage of a car. A car may even be cost inefficient for the distance needed to travel to work or within the area in general when the cost of fuel, insurance, and parking is taken into consideration.

Some may enjoy the use of a bicycle for nearby travel/commuting. However conventional bicycles expose one to the elements and lack sufficient means for carrying cargo needed on a daily basis (for example, brief cases, laptops, multiple nags of groceries, etc.). The use of a conventional bicycle may be thwarted by even the lightest of rains as two wheeled vehicles are prone to slipping and crashing. Other bicycles such as recumbents are built for competition and place the rider too low to appreciate the dangers and traffic surrounding him or her. Their movement between traffic is especially dangerous. Moreover, conventional bicycles rely on people power and may be difficult to power in hilly urban areas.

As can be seen, there is a need for a vehicle that is cost-efficient and protects one from the environment within an urban commuting setting.

### SUMMARY

According to one embodiment of the subject technology, an enclosed electric tricycle comprises a tricycle frame including two forward wheels and one rearward wheel; a handlebar connected to the tricycle frame positioned intermediate the two forward wheels and one rearward wheel; a seat connected to the tricycle frame, the seat positioned intermediate the handlebar and the one rearward wheel; a pedal connected to the tricycle frame, the pedal positioned below a seated plane of a rider and rearward of the handlebar; a chain on a gear connecting the pedal to either the rearward wheel or the two forward wheels; an electric motor coupled to the chain for providing an electromotive force to the chain; and an enclosure shell configured to surround the rider and the tricycle frame.

According to another embodiment, an enclosed electric tricycle comprises a tricycle frame including two forward wheels and one rearward wheel; a handlebar connected to the tricycle frame positioned intermediate the two forward wheels and one rearward wheel; a cargo basket connected to the tricycle frame positioned forward of the handlebar and intermediate the two forward wheels; a non-recumbent seat connected to the tricycle frame, the seat positioned intermediate the handlebar and the one rearward wheel; a pedal connected to the tricycle frame, the pedal positioned below a seated plane of a rider and rearward of the handlebar; a chain on a gear connecting the pedal to either the rearward wheel or the two forward wheels; and an electric motor coupled to the chain for providing an electromotive force to the chain; an enclosure shell configured to surround the rider and the tricycle frame, wherein the enclosure shell includes: a front face of a first width, a rear face of a second width, the second width narrower than the first width, a door in the enclosure shell, the door positioned adjacent the seat, and a fender over each of the forward two wheels.

### BRIEF DESCRIPTION OF THE FIGURES

The detailed description of some embodiments of the present invention is made below with reference to the accompanying figures, wherein like numerals represent corresponding parts of the figures.

FIG. 1 is a top, front perspective view of an enclosed electric tricycle in accordance with an exemplary embodiment of the subject technology.

FIG. 2 is an exploded view of the enclosed electric tricycle of FIG. 1.

FIG. 3 is top, rear perspective view of the enclosed electric tricycle of FIG. 1.

FIG. 4 is a side view of the tricycle frame without an enclosure shell in accordance with an exemplary embodiment of the subject technology.

FIG. 5 is a bottom view of the tricycle frame of FIG. 4.

FIG. 6 is a front end view of the tricycle frame of FIG. 4.

FIG. 7 is a top perspective view of the tricycle frame of FIG. 4.

FIG. 8 is an enlarged partial bottom view taken along the line 8-8 of FIG. 7.

### DETAILED DESCRIPTION OF CERTAIN EMBODIMENTS

The word “exemplary” is used herein to mean “serving as an example or illustration.” Any aspect or design described herein as “exemplary” is not necessarily to be construed as preferred or advantageous over other aspects or designs.

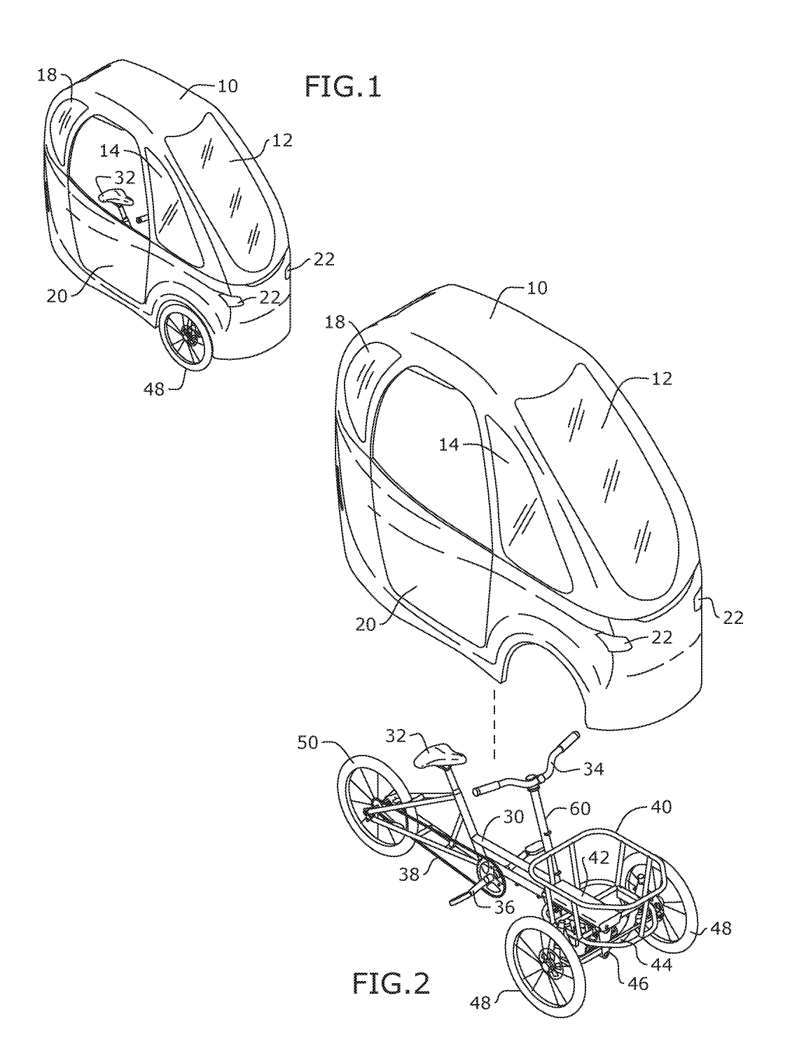

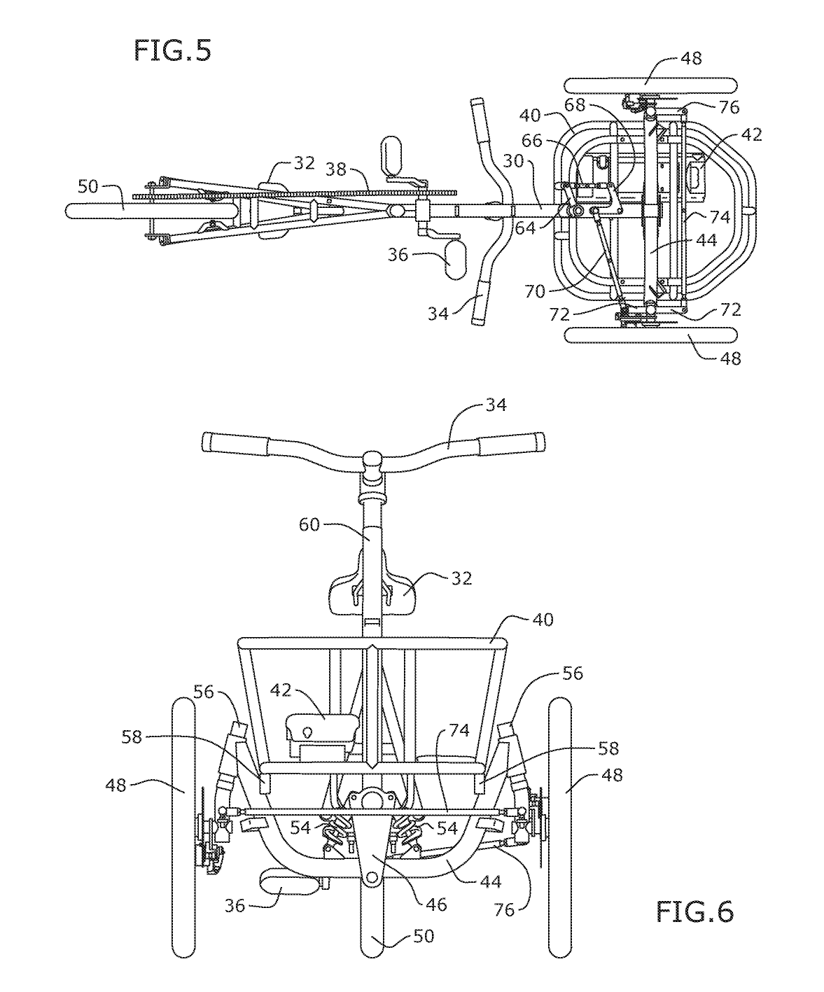

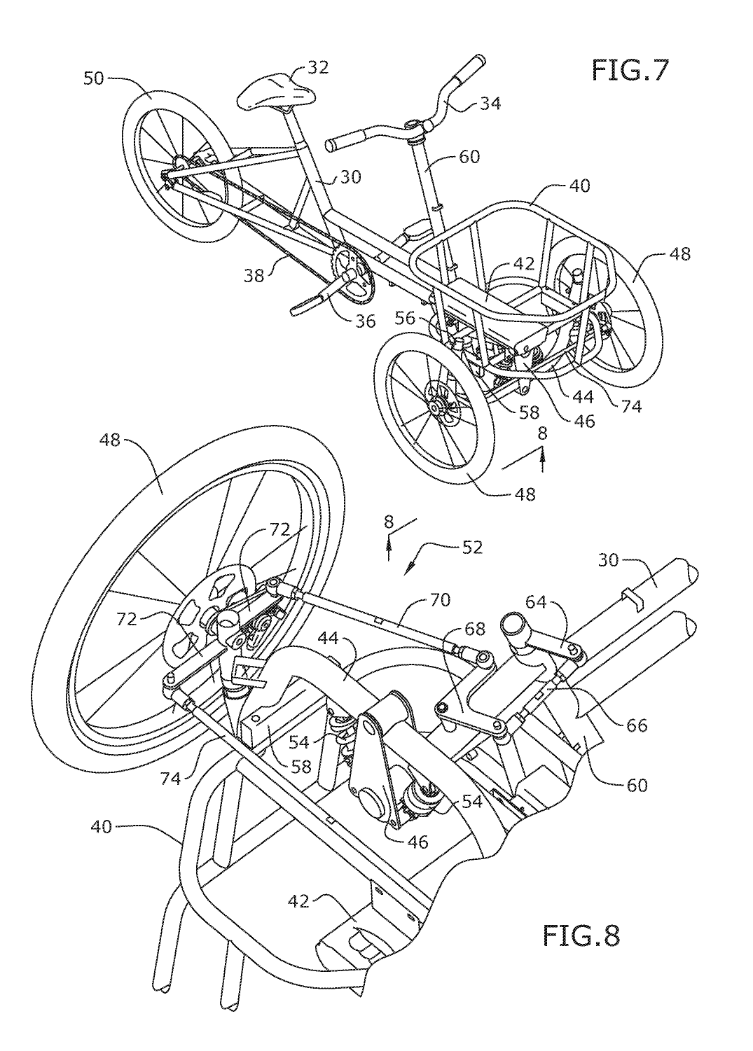

Referring now to FIGS. 1-8 and in general, exemplary embodiments provide an enclosed electric tricycle for stable, agile maneuverability and aerodynamic efficiency in an urban commuting environment. As will be appreciated, aspects of the enclosed electric tricycle keep it balanced, protect the rider from the environment (for example, wind-chill, slight rain, and sun), and allow the rider higher visibility to see and be seen by car drivers. In addition, the width of the enclosed electric tricycle may be narrow, for example, less than 44 inches wide to keep it agile enough to move in between traffic. An electric assist feature provides the rider supplemental power during a commute, which may be especially helpful in hilly areas or longer distance commutes.

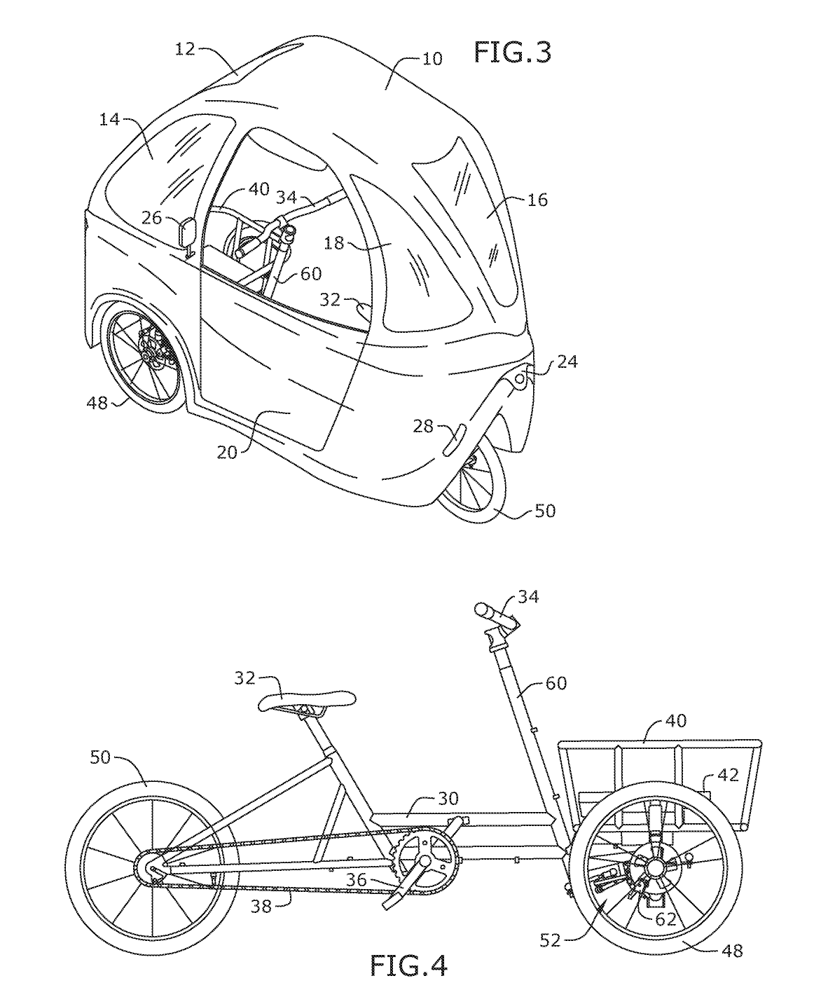

Referring to FIGS. 1-3, the enclosed electric tricycle may include an enclosure shell 10 configured to surround a raider (not shown) and a tricycle main frame 30. The enclosure shell 10 may include a door 20 disposed to allow the rider to enter the enclosure shell 10 and walk into position over a seat 32. The enclosure shell 10 may be configured to allow the rider to sit up high on the seat 32 so the rider can see through an enclosure windshield 12 (and if needed through front side windows 14, rear side windows 18, and rear window 16) to view surrounding traffic. For sake of illustration, attachment points between the shell 10 and the frame 30 are not shown but are considered readily apparent to one skilled in the art. In some embodiments, the enclosure shell 10 may include headlights 22, a taillight 24, and/or a reflector 28 providing visibility in low light settings. The enclosure shell 10 may taper in width from the front end to the rear end providing an aerodynamic shape that reduces the pedal power or electric assist needed for movement. For example, the enclosure shell 10 may include a front face of a first width and a rear face (FIG. 3) of a second width with the second width narrower than the first width. I some embodiments, the enclosure shell 10 may include a fender for one or more of the wheels 48, 50. Referring now to FIGS. 2-8, the tricycle portion of the enclosed electric tricycle is shown according to an exemplary embodiment. The enclosed electric tricycle may include two forward wheels 48 and one rearward wheel 50. As may be appreciated, using a tricycle design promotes stability. By using two forward wheels 48, there is additional stability changing lanes and turning in/out of turns. A handlebar 34 may be connected to the tricycle frame 30 by a steering column 60. The handlebar 34 may be positioned intermediate the two forward wheels 48 and the one rearward wheel 50. The handlebar 34 is generally upright and below the rider's head and disposed for upright riding (unlike a recumbent bike's handlebars which are generally biased level to the user's head as the user lays almost planar to the floor).

Steering mechanisms 52 may be coupled to the steering column 60 for turning the wheels 48. For example, the steering column 60 may be connected to the wheels 48 by way of a steering clevis 64 coupled to a steering linkage 66 coupled to a steering arm 68 coupled to a main steering rod 70. A main steering tie-rod 74 connected to respective wheel's arms 56 may brace the two wheels 48 and a turning linkage 72 on one of the wheels 48 coupled to the steering rod 70 (along with a turning linkage 76 on the opposing wheel 48) may provide turning. Some embodiments may include a suspension springs 54 connected to the wheel arms 56.

In an exemplary embodiment, the enclosed electric tricycle may be useful for carrying cargo as one would need for a daily commute in urban environments. Some embodiments include a cargo basket 40 positioned forward of the handlebars 34 and between the wheels 48 coupled to the frame 30 by basket supports 58 attached to for example a cross member frame 44 via brace(s) 46.

In an exemplary embodiment, the seat 32 may be positioned intermediate the handlebar 34 and the one rearward wheel 50. Generally the seat 32 may be planar to the floor for upright riding. A pedal 36 (or pair of pedals 36) are connected to the tricycle frame 30 via a gear as is known in the art. The pedal(s) 36) may be positioned below a seated plane of the rider and rearward of the handlebar 34 so that the rider pushes generally down toward gravity (unlike a recumbent bike's pedals which are generally on or near the same plane as the seat so that the rider pushes the pedals parallel to the floor). A chain 38 on the gear connects the pedal(s) 36 to either the rearward wheel 50 or in some embodiments the two forward wheels 48.

In an exemplary embodiment, a battery 42 powers an electric motor (not shown) coupled to the chain 38 for providing an electromotive force to either the rearward wheel 50 or in some embodiments the two forward wheels 48.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

Terms such as “top,” “bottom,” “front,” “rear,” “above,” “below” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference. Similarly, an item disposed above another item may be located above or below the other item along a vertical, horizontal or diagonal direction; and an item disposed below another item may be located below or above the other item along a vertical, horizontal or diagonal direction.

What is claimed is:

1. An enclosed electric tricycle, comprising:
a tricycle frame including two forward wheels and one rearward wheel;
a handlebar connected to the tricycle frame positioned intermediate the two forward wheels and one rearward wheel;
a seat connected to the tricycle frame, the seat positioned intermediate the handlebar and the one rearward wheel;
a pedal connected to the tricycle frame, the pedal positioned below a seated plane of a rider and rearward of the handlebar;
a chain on a gear connecting the pedal to either the rearward wheel or the two forward wheels;
an electric motor coupled to the chain for providing an electromotive force to the chain; and
an enclosure shell configured to surround the rider and the tricycle frame.

2. The enclosed electric tricycle of claim 1, further comprising a cargo basket connected to the tricycle frame positioned forward of the handlebar and intermediate the two forward wheels.

3. The enclosed electric tricycle of claim 1, wherein the tricycle is non-recumbent.

4. The enclosed electric tricycle of claim 1, further comprising a door in the enclosure shell, the door positioned adjacent the seat.

5. The enclosed electric tricycle of claim 1, wherein the enclosure shell includes:
a front face of a first width; and
a rear face of a second width, the second width narrower than the first width.

6. The enclosed electric tricycle of claim 1, wherein the enclosure shell includes a fender over each of the forward two wheels.

7. An enclosed electric tricycle, comprising:
a tricycle frame including two forward wheels and one rearward wheel;
a handlebar connected to the tricycle frame positioned intermediate the two forward wheels and one rearward wheel;
a cargo basket connected to the tricycle frame positioned forward of the handlebar and intermediate the two forward wheels
a non-recumbent seat connected to the tricycle frame, the seat positioned intermediate the handlebar and the one rearward wheel;
a pedal connected to the tricycle frame, the pedal positioned below a seated plane of a rider and rearward of the handlebar;
a chain on a gear connecting the pedal to either the rearward wheel or the two forward wheels; and
an electric motor coupled to the chain for providing an electromotive force to the chain;
an enclosure shell configured to surround the rider and the tricycle frame, wherein the enclosure shell includes:
a front face of a first width,
a rear face of a second width, the second width narrower than the first width,
a door in the enclosure shell, the door positioned adjacent the seat, and
a fender over each of the forward two wheels.
